(19) United States
(12) Patent Application Publication
(10) Pub. No.: US 2014/0026767 A1
(43) Pub. Date: Jan. 30, 2014

(54) Manual Baler for Recycling Thin Plastic Sheet Material

(71) Applicant: Zeus Recycling Solutions, LLC., Sheboygan, WI (US)

(72) Inventors: James Theodoroff, Sheboygan, WI (US); Peter J. Phillips, Mundelein, IL (US); Galinos P. Phillips, Gurnee, IL (US)

(73) Assignee: Zeus Recycling Solutions, LLC., Sheboygan, WI (US)

(21) Appl. No.: 13/945,414

(22) Filed: Jul. 18, 2013

Related U.S. Application Data
(60) Provisional application No. 61/677,360, filed on Jul. 30, 2012.

(51) Int. Cl. B65B 13/20; B30B 15/32; B30B 15/06; B65B 13/02; B30B 9/30

(52) U.S. Cl. CPC B65B 13/20; B65B 13/025; B30B 9/306; B30B 15/06; B30B 15/32
USPC 100/3; 100/8; 100/252; 100/100

(57) ABSTRACT

A manual baler for compressing thin plastic sheeting for efficient recycling including downwardly extending fingers on the compression plate that serve to gather and retain the plastic sheeting during compression and a latch and twine threading system for holding the bale in compression while allowing ties to be wrapped around the bale to retain it in a compressed state.

### CROSS REFERENCE TO RELATED APPLICATION

This application claims the benefit of U.S. provisional application 61/677,360 filed Jul. 30, 2012 and hereby incorporated in its entirety by reference.

### BACKGROUND OF THE INVENTION

The present invention relates to a baler for compressing loose material into compact bales and in particular to a baler that can facilitate the recycling of voluminous thin plastic sheeting.

Thin plastic sheets and films find increasing use in modern commerce. Plastic “stretch film” may be wrapped around shipped items to stabilize, secure, and protect those items. Hospitals used large volumes of so-called “blue wrap” as part of the sterilization process of hospital instruments. Plastic films and grocery bags are used extensively in modern supermarkets.

After use, these thin plastic films become unwanted waste that is difficult to recycle. A common solution is to collect loose plastic film material into “gaylord” containers (boxes approximating a 42 inch cube); however, such containers present signficant storage problems in themselves and are costly to ship, substantially consuming the recycling value of the contained material in shipping costs.

On site powered baling units can be used to increase the density of such waste film for shipping, but baling units may be impractical for sites with dispersed waste generation locations necessitating a transport of loose film to the baler or the use of multiple baling units at additional cost. In facilities where space is limited, such as hospitals, large powered baling units are impractical.

### SUMMARY OF THE INVENTION

The present invention provides a compact manual baler that is easily located at or moved between different waste generation locations to compress loose plastic film into recyclable bales. The baler provides multiple features to allow efficient handling of thin plastic sheet including a compression plate with downwardly extending flexible fingers that reduce jamming of the compression mechanism by plastic film slipping between the compression plate and the walls of the baler and a mechanism for holding the bale in compression while restraining ties are put in place.

Specifically, the present invention provides a manual baler for forming bales from material. The baler provides a container having sidewalls extending upward about a base to define a volume opening upward to receive material. The container has at least one displaceable sidewall to allow removal of the material through a side opening created by displacement of the sidewall. A compression plate is attached to a lever having a first and second end, the first end pivotally communicating with the container so that the compression plate may be compressed downward into the volume by manual movement of the second end to compress the material in the volume. A catch is provided for retaining the compression plate in downward extension against upward forces by the material as well as at least one vertical slot in the displaceable sidewall allowing twine to be tied around a bale of compressed material under compression in the container with the sidewall undisplaced followed by displacement of the sidewall to remove the bale.

It is thus a feature of at least one embodiment of the invention to provide a baler that can accommodate the elastic nature of thin plastic wraps causing them to recoil after compression both because of the elastic quality of the plastic and entrained air. The catch and slots allow tying of the bale while it is in compression.

The catch may automatically engage when the lever is in a full downward stroke position and may be manually disengaged.

It is thus a feature of at least one embodiment of the invention to provide a manual system that may be readily operated by a single individual. Automatic engagement of the catch allows the operator to use both hands on the lever to fully compress the material.

The lever may be attached to a spring biasing the lever and compression plate in an upward position.

It is thus a feature of at least one embodiment of the invention to provide an ability to park the compression plate in an upward position so as not to interfere with access to the opening of the container permitting the container to be loaded with thin plastic sheet or the like.

The compression plate may attach to the lever by means of a strut extending between a top surface of the compression plate and the lever to attach to the lever between the first and second ends. The strut may pivot so that the compression plate may be removed from above the volume of the container.

It is thus a feature of at least one embodiment of the invention to allow the compression plate to be pulled forward for superior access to the container for loading the container.

When the compression plate is biased in an upward position, an upper rear surface of the compression plate may interlock with a front sidewall edge of the container preventing upward movement when the compression plate is removed from above the volume to a front of the container.

It is thus a feature of at least one embodiment of the invention to secure the compression plate against inadvertent interference with the loading of the container.

The manual baler may further include tabs on an outer surface of non-displaceable sidewall opposite the displaceable sidewall for retaining twine attached to the tabs to loop over an upper edge of the non-displaceable sidewall into the volume and out of the slots.

It is thus a feature of at least one embodiment of the invention to provide a simple one person tying of the bales by providing a way of holding loose ends of tying twine or the like during the baling process.

The second end of the lever may have handlebars extending substantially perpendicularly from the second end to be grasped by hands of a user facing the baler.

It is thus a feature of at least one embodiment of the invention to encourage effective two-handed compression techniques by operators of the baler.

The compression plate may attach to the lever by means of a telescoping strut communicating between a top surface of the compression plate and the lever between the first and second ends, the telescoping strut including a lock holding either of two extension lengths against compression to allow steps of compaction of the plastic material with the telescoping strut in each of the two extension lengths.

It is thus a feature of at least one embodiment of the invention to accommodate the substantial compression required of loose thin film plastic while limiting the lever to a mechanically advantageous range using successive extensions of the strut.

The manual baler may further include a pair of wheels positioned at a lower edge of a given sidewall opposite the displaceable sidewall and a handle positioned at an upper edge of the given sidewall to be grasped to tip the container to rest solely on the wheels for transportation.

It is thus a feature of at least one embodiment of the invention to provide a baler that may be readily transported to locations in which thin plastic sheet or the like accumulate.

The compression plate may include on its lower face abutting the material in the volume, multiple downwardly extending fingers sized to deform and draw plastic sheet material at an interface with the compression plate away from the walls of the container during compression of the material.

It is thus a feature of at least one embodiment of the invention to accommodate the tendency of thin plastic sheeting to slip between a compressing plate and a sidewall of the container, jamming the same.

The fingers may extend at least one-half inch downward.

It is thus a feature of at least one embodiment of the invention to provide for a compression plate adapted for use with thin plastic film

The fingers may be an elastomeric material.

It is thus a feature of at least one embodiment of the invention to provide fingers that better engage and retain the plastic film during the compression process.

These particular objects and advantages may apply to only some embodiments falling within the claims and thus do not define the scope of the invention.

### BRIEF DESCRIPTION OF THE DRAWINGS

FIG. 1 is a perspective view of a manual baler according to the present invention having a manually operated lever communicating by means of a strut to a compression plate fitting within a container, the container having a front sidewall door shown in an open position for removing a bale;

FIG. 2 is a perspective view of the compression plate and the strut showing the latter's telescopic construction and showing film-retaining fingers extending downward from the bottom of the compression plate;

FIGS. 3a and 3b are simplified side elevational cross-sections of the manual baler of FIG. 1 showing two stages of compression of a bale with the strut in a first short and second longer position;

FIG. 4 is a fragmentary perspective view of an upper end of the container of the manual baler of FIG. 1 with the lever, strut, and compression plate and supporting elements removed to better show tabs on a rear wall for supporting baling twine or the like to be threaded downward into the container and out of the slots in the front door of the container;

FIGS. 5a and 5b are simplified elevational views similar to FIGS. 3, the first showing the compression plate in a stowed position for insertion of material into the container and the positioning of the twine prior to that insertion and the second showing additional compression of the material after threading of the twine around the bale and then continued compression while the twine is tied with the lever in a latched downward position;

FIG. 6 is a fragmentary side view of the compression plate in the stowed position and showing an interlocking between a front lip of the container and the rear lip of the compression plate retained by upward biasing of a spring (not shown in FIG. 6);

FIG. 7 is a fragmentary detail side view of the lever as latched to a front edge of the container, for example, in the position shown in FIG. 5b;

FIG. 8 is a fragmentary rear view of the container with the lever removed for clarity showing wheels and a handle allowing ready transportation of the container;

FIG. 9 is an exploded perspective view of the container of the manual baler of FIG. 1, with the handle removed for clarity, showing installation of a baling bag allowing the manual baler to have additional use in compressing conventional loose materials that are difficult to bale such as aluminum cans; and

FIG. 10 is a figure similar to that of FIG. 2 showing an alternative compression plate suitable for use with cans, this compression plate promoting dimpling and then buckling of the can material.

### DETAILED DESCRIPTION OF THE PREFERRED EMBODIMENT

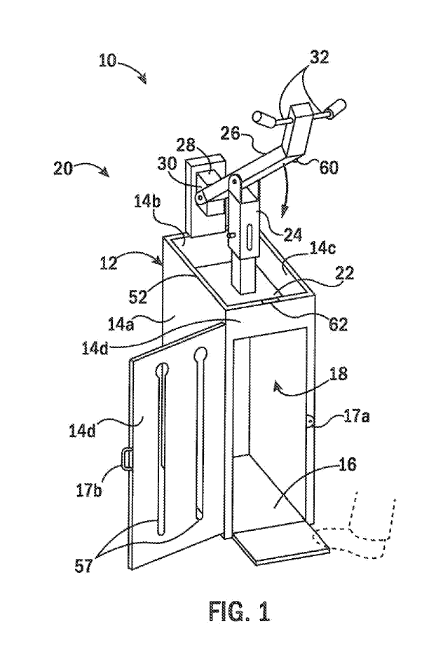

Referring now to FIG. 1, a manual baler 10 following the teachings of the present invention may generally provide a container 12 having tour planar walls 14 including a left sidewall 14a, a rear wall 14b, a right sidewall 14c and a front wall 14d each extending upward from corresponding edges of a lower rectangular base 16 and joined at vertical edges to define a volume 18 therebetween.

A lower portion of the front wall 14d operates as a door that is hinged at one vertical edge to be displaced from the volume 18 by swinging open to allow removal of a compressed bale (to be discussed below) through that opening. The front wall 14d may be latched in a closed position by means of a latch elements 17a at a font edge of right sidewall 14c joining with corresponding latch elements 17b on a corresponding edge of front wall 14d.

The container 12 provides an opening at an upper end 20 to allow the insertion of material downward into the volume 18 from that end 20. As shown in FIG. 1, during a compression process, that opening may be blocked by a generally rectangular compression plate 22 extending horizontally within and between the walls 14 and movable vertically into and out of the volume 18.

The compression plate 22 is attached near a center of its upper side to the lower end of a strut 24, for example, by welding the strut 24 extending perpendicularly upward from the compression plate 22. The upper end of the strut 24 may be pivotably attached to a lever 26 between the ends of the lever 26, the latter of which is positioned above the compression plate 22.

The lever 26 may extend from the rear of the container 12 forward over the front wall 14d. At its rear end, the lever 26 is attached at pivot 28 to a support 30 attached to the container 12 at a center of an upper edge of rear wall 14b opposite front wall 14d when that rear wall 14b is in a closed position.

A front end of the lever 26 extends forward beyond the front wall 14d (when the front wall 14d is in the closed position) to attach to a set of handlebars 32 extending laterally (that is horizontally and perpendicularly to the extent of the lever 26) on either side of the second end of the lever 26. The handlebars are configured to be grasped, for example, by a left and right hand of the user facing the container 12 from its front. By raising or lowering the handlebars 32, the user may raise or lower the compression plate 22 with the mechanical advantage provided by the lever being determined by the relative distance between the location of the pivot 28 and the strut 24 and the distance between the strut 24 and the handlebars 32. Generally this former distance is much smaller than this latter distance to provide approximately 2:1 or greater mechanical advantage.

Each of the above-described components may be constructed, for example, of steel plate and steel tubing as context would require to provide a rugged assembly that may withstand forces anticipated in the baling action to be discussed.

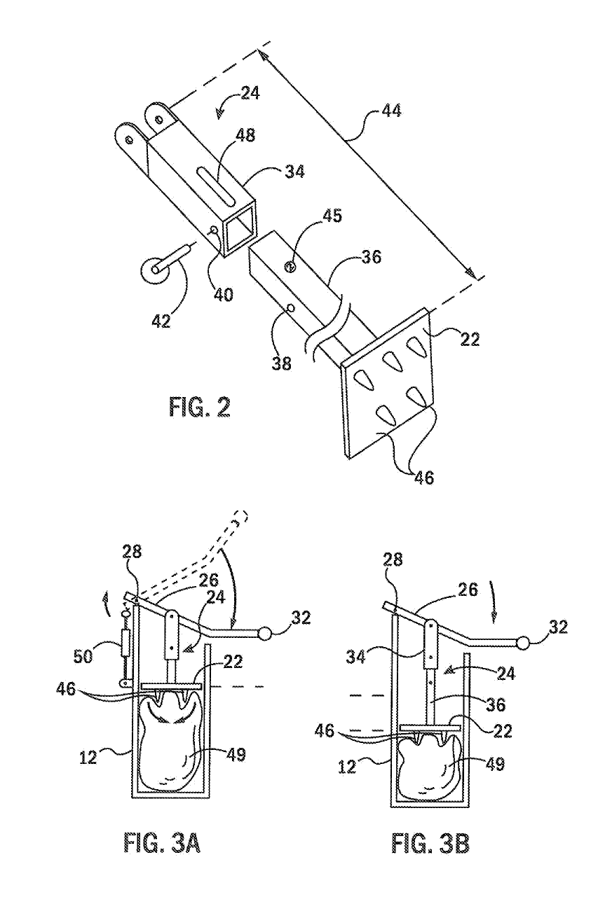

Referring, now to FIG. 2, the strut 24 may provide for a telescoping construction in which an outer upper rectangular tube 34 of the strut 24 fits concentrically around a lower rectangular tube 36 of the strut 24 so that the latter may slide within the former in a straight line restrained against rotation. One or more holes 38 are cut across the axis of tube 36 to align at different relative extensions of tube 36 within tube 34 with a corresponding hole 40 into tube 34. The relative position of tube 36 with respect to tube 34 may be held in either of the least two extension lengths 44 by a pin 42, for example, retained by a mechanical detent (such as a spring-loaded ball) on the pin 42 interacting with an inner surface of the holes 38. Indicia 45 may be stamped or cut on one outer face of the inner tube 36 so that the indicia 45 align with a port 48 cut in a corresponding face of tube 34 to be displayed there to indicate the particular length 44 selected.

A lower surface of the compression plate 22 supports a series of downwardly cone-shaped extending elastomeric fingers 46 with the base of the cones abutting and attached to a lower surface of the compression plate 22. In one embodiment, the fingers 46 may extend downward by approximately 1-2 inches. Referring momentarily to now to FIG. 3a, in operation of the manual baler 10, the fingers 46 serve to make initial contact with a bolus of loose plastic sheet material 49 as the compression plate 22 is lowered on the sheet plastic material 49 previously introduced into the container 12. While the inventors do not wish to be bound by a particular theory, it is believed that the fingers 46 both prevent migration of the material of the plastic sheet material 49 such as would promote its jamming between the compression plate 22 and the inner walls of the container 12 and, by deforming the upper surface of the plastic sheet material 49, draw that upper surface inward away from the walls of the container 12 facilitating compaction without jamming. Placement of the fingers 46 and their number may be adjusted for different materials by observation. The plastic sheet material 49 may, for example, be polyethylene stretch wrap or polypropylene hospital blue wrap typically having a gauge from 50 to 80 for stretch wrap (0.5-0.8 mils).

Referring to FIGS. 1, 2, and 3a, the telescoping action of the strut 24 may be used to provide for two stages of compression of the sheet plastic material 49 allowing the motion of the lever 26 to be constrained within a range of convenient and efficient operation by an operator. In the first stage of compression, the length of the strut 24 is reduced to its smallest extent and sheet plastic material 49 compressed by a first amount, for example, achieved with successive introduction of material into the container 12 and compression with the lever 26, the latter pulled fully down. Referring now to FIGS. 2 and 3b, the strut may then be adjusted by removal of the pin 42 and extension of tube 36 to increase the length of the strut 24 so that pulling of the lever 26 to its full downward position, as shown, provides greater compression of the sheet plastic material 49.

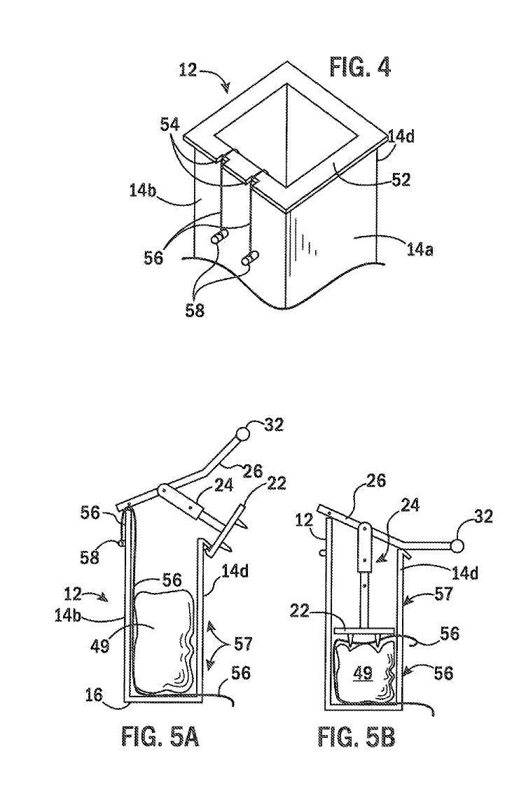

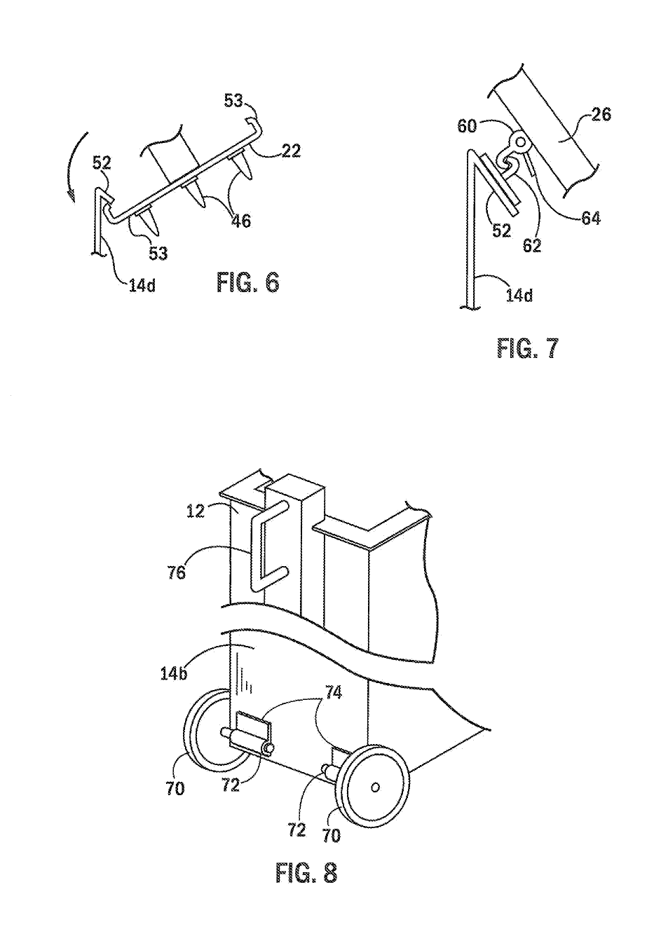

Referring again to FIGS. 3a, 5a, and 6, the lever 26 may extend slightly past the pivot 28 behind the rear of the container 12, to attach to a gas spring 50 (or hydraulic damper) that may serve to pull down on the rear end of the lever 26 projecting beyond the pivot 28 to bias the handlebars 32 upward and hence to bias the compression plate 22 upward. With this upward bias, the lever 26 will be stably raised fully and compression plate 22 will be parked out of the container 12 with its lower rear edge adjacent to the outer upper edge of front wall 14d above the door portion of the front wall 14d. Referring momentarily to FIGS. 1 and 4, the upper edges of the sidewalls 14 of the container 12 may be folded outward to provide a rim 52. As shown in FIG. 6, a front portion of the rim 52 associated with the upper portion of the front wall 14d may hook with a second rim 53 surrounding the periphery of the compression plate 22, the two held engaged by the upward force of the compression plate 22 as transmitted through the lever 26 from the gas spring 50. In this parked position of the compression plate 22, material may be freely added to the interior volume 18 of the container 12 without interference from the compression plate 22.

Referring to FIGS. 4 and 5a, portions of the rim 52 associated with the rear wall 14b may include two guide slits 54 extending inward from outer peripheral edge of the rim 52 and having a separation substantially equal to a separation of corresponding vertical door slots 57 in the door portion of front wall 14d. These door slots 57 extend substantially a full height of the door portion of the front wall 14d with the exception of short upper and lower margins of the door required to retain door integrity. Ends of twine 56 or other bale-tying material may be attached to each of two tabs 58 extending outward from a rear surface of the rear well 14b aligned with but just below the guide slits 54.

Referring still to FIGS. 4 and 5a, a remainder of the length of the twine 56 is then guided upward through the guide slits 54 and downward along the inner surface of the rear wall 14b across the base 16 and out through the door slots 57. After positioning of the twine 56, and with the compression plate 22 in the parked position described above, loose sheet plastic material 49 may be inserted into the container 12 for the first stages of compression previously described with respect to FIG. 3a above.

After this first stage of compression, the compression plate 22 may be raised and the ends of the twine 56 removed from the tabs 58 and threaded through the upper ends of the door slots 37 of the door portion of front wall 14d over the top of a bolus of the material 49. As shown in FIG. 5b, the second stage of compression may be undertaken with the strut 24 in its extended position and the twine 56 between the bolus of material 49 and the compression plate 22.

Referring now also to FIG. 7, at this point, a full downward stroke of the lever 26 brings together catch element 60 on lever 26 and catch element 62 on the rim 52 of the front wall 14d which engage, holding the lever 26 down against the gas spring 50 (shown in FIG. 3a) and the elastic recoil of the material 49. The latch formed of catch elements 60 and 62 may automatically engage when the lever 26 is in the full downward position. This automatic engagement may be by spring biasing (not shown) of either of the catch elements 60 and 62 according to methods well known in the art. After automatic engagement, the catch elements 60 and 62 may be released by manual operation of lever 64, for example, on catch element 60.

As so compressed and held, the opposite ends of each length of twine 56 extending through the slots 57 above and below the bolus of material 49 may be tied together to retain the material 49 in its compressed state in a bale. Referring again to FIG. 1, after these ends of twine 56 are tied together, the catch elements 60 and 62 may then be released and the door portion of the front wall 14d may be opened and the bale removed, the door slots 57 allowing free passage of the tied twine 56 holding material 49.

A portion of the base 16 may extend forward from the container 12 beneath the closed position of the front wall 14d so that it may be held against a floor, for example, by the user's foot during the bale extraction process stabilizing the container 12 by preventing it from following with the removed bale. It will be appreciated that the latching provided by catch elements 62 and 64 shown in FIG. 7 may be engaged for a period of time after each compression to allow the compressed material 49 to “set” prior to adding more material so that the previously compressed material 49 does not re-expand substantially when the compression plate 22 is retracted upward.

Referring now to FIG. 8, wheels 70 may be attached to a lower outer edge of rear wall 14b by means of short axle stubs 72 in turn supported by pillow flanges 74 welded to the back of rear wall 14b. The short axle stubs 72 are generally parallel to the lower edge of the rear wall 14b and coaxial but do not extend the full width of the rear wall 14b eliminating possible damage or misalignment of a full axle. The wheels 70 allow the container 12 to be tipped backward by means of a handle 76 placed, for example, near the upper rear edge of rear wall 14b. In this way the manual baler 10 may be freely wheeled from location to location and may be placed, for example, in a closet for storage in between use.

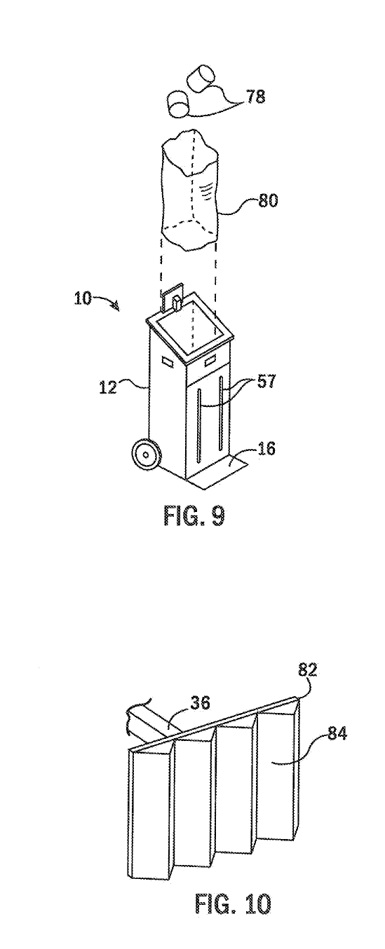

Referring now to FIGS. 9 and 10, the manual baler 10 of the present invention may find additional use in the compression and baling of conventional items. For example, aluminum cans 78 may be compressed in the container 12 by first placing a square bottomed plastic hag 80 as a liner in the container 12. A square bottom plastic bag 80, as is understood in the art, is generally seamed to conform in a relaxed but opened state to a rectangular volume 18 thus to resist tearing under the forces of compressed material pressing the bag 80 outward because the material of the bag 80 is fully supported against the walls of the container 12 and the base 16.

The process of compression for other materials such as cans 78 may be substantially the same as described with respect to FIGS. 3a and 3b but for the addition of the plastic bag 80 and may include or not include the use of twine as shown in the previous discussion pending on the inherent elasticity of the compressed material. For compression of conventional materials, the compression plate 22 may be replaced with the compression plate 82 having for example, rigid teeth 84 in the form of a rectangular corrugation that serves to produce points of high pressure on the cans that promote their dimpling and buckling for better compression. The replacement is done easily by removing the compression plate 22 and attached tube 36 by releasing pin 42 (shown in FIG. 2).

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A manual baler for forming bales from material comprising:
a container having sidewalls extending upward about a base to define a volume opening upward to receive the material therein and having at least one displaceable sidewall to allow removal of the material through a side opening created by displacement of the sidewall;
a compression plate attached to a lever having a first and second end, the first end pivotally communicating with the container so that the compression plate may be compressed downward into the volume by manual movement of the second end to compress the material in the volume;
a catch for retaining the compression plate in downward extension against upward forces by the material; and
at least one vertical slot in the displaceable sidewall allowing twine to be tied around a bale of compressed material under compression in the container with the sidewall undisplaced followed by displacement of the sidewall to remove the bale.

2. The manual baler of claim 1 wherein the catch automatically engages when the ever is in a full downward stroke position and may be manually disengaged.

3. The manual baler of claim 1 wherein the lever is attached to a spring biasing the lever and compression plate in an upward position.

4. The manual baler of claim 1 wherein the compression plate attaches to the lever by means of a strut extending between a top surface of the compression plate and the lever to attach to the lever between the first and second ends, the strut pivoting so that the compression plate may be removed from above the volume away from interference with material being placed downward into the volume.

5. The manual baler of claim 4 wherein the lever is attached to a spring biasing the lever and compression plate in an upward position and wherein an upper rear surface of the compression plate and a front sidewall edge of the container interlock against upward movement when the compression plate is removed from above the volume to a front of the container.

6. The manual baler of claim 1 further including at least one tab on an outer surface of a non-displaceable sidewall opposite the displaceable sidewall for retaining twine attached to the tab to loop over an upper edge of the non-displaceable sidewall into the volume and out of the at least one slot.

7. The manual baler of claim 1 wherein the second end of the lever provides for handlebars extending substantially perpendicularly from the second end to be grasped by hands of a user facing the baler.

8. The manual baler of claim 1 wherein the compression plate attaches to the lever through a telescoping strut attached between a top surface of the compression plate and the lever between the first and second ends of the lever, the telescoping strut including a lock holding either of two extension lengths against compression to allow steps of compaction of the material with the telescoping strut in each of the two extension lengths.

9. The manual baler of claim 1 further including a pair of wheels positioned at a lower edge of a given sidewall opposite the displaceable sidewall and a handle positioned at an upper edge of the given sidewall to be grasped to tip the container to rest solely on the wheels for transportation.

10. The manual baler of claim 1 wherein the compression plate includes on a lower face for abutting the material in the volume, multiple downwardly extending fingers sized to deform and draw the material at an interface with the compression plate away from the walls of the container during compression of the material.

11. A manual baler for forming bales from flexible plastic sheet material comprising:
a container having sidewalls extending upward about a base to define a volume opening upward to receive the material therein and having at least one displaceable sidewall to allow removal of the plastic sheet material through a side opening created by displacement of the sidewall; and
a compression plate attached to a lever communicating with the container so that the compression plate may be compressed downward into the volume to compress the plastic sheet material therein with manual activation of the lever;
wherein the compression plate includes on a lower face abutting the plastic sheet material in the volume multiple downwardly extending fingers sized to deform and draw plastic sheet material at an interface with the compression plate away from the walls of the container during compression of the plastic sheet material.

12. The manual baler of claim 11 wherein the fingers extend at least one half inch downward.

13. The manual baler of claim 12 wherein the fingers are an elastomeric material.

14. The manual baler of claim 11 wherein the lever is attached to a spring biasing the lever and compression plate in an upward position.

15. The manual baler of claim 11 wherein the compression plate attaches to the lever by means of a strut attached between a top surface of the compression plate and the lever between first and second ends of the lever, the strut pivoting so that the compression plate may be removed from above the volume away from interference with material being placed downward into the volume.

16. The manual baler of claim 15 wherein the lever is attached to a spring biasing the lever and compression plate in an upward position and wherein an upper rear surface of the compression plate and a front sidewall edge of the container interlock against upward movement when the compression plate is removed from above the volume to a front of the container.

17. The manual baler of claim 11 further including at least one tab on an outer surface of a non-displaceable sidewall opposite the displaceable sidewall for retaining twine attached to the at least one tab to loop over an upper edge of the non-displaceable sidewall into the volume and out of the at least one slot.

18. The manual baler of claim 11 wherein the second end of the lever provides for handlebars extending substantially perpendicularly from the second end to be grasped by hands of a user facing the baler.

19. The manual baler of claim 11 further including a pair of wheels positioned at a lower edge of a given sidewall opposite the displaceable sidewall and a handle positioned at an upper edge of the given sidewall to he grasped to tip the container to rest solely on the wheels for transportation.

20. A method of forming bales from flexible plastic film using a manual baler having:
a container having sidewalls extending upward about a base to define a volume opening upward to receive the flexible plastic film therein and having at least one displaceable sidewall to allow removal of the flexible plastic film through a side opening created by displacement of the sidewall;
a compression plate attached to a lever communicating with the container so that the compression plate may be compressed downward into the volume to compress the flexible plastic film therein with manual activation of the lever;
wherein the compression plate includes on a lower face abutting the flexible plastic film in the volume multiple downwardly extending fingers sized to deform and draw the flexible plastic film at an interface with the compression plate away from the walls of the container during compression of the flexible plastic film; the method comprising the steps of
(a) inserting flexible plastic film into the container;
(b) lowering the compression plate on the contained flexible plastic film using the lever so that the multiple downwardly extending fingers deform and draw the plastic sheet film as an interface with the compression plate away from walls of the container during compression of the plastic film;
(c) tying the plastic film while compressed with twine or the like and forming a bale; and
(d) displacing the wall to remove the bale from the container.
